(19) United States
(12) Patent Application Publication
(10) Pub. No.: US 2007/0283262 A1
(43) Pub. Date: Dec. 6, 2007

(54) Recursive browser system and uses therefor

(76) Inventor: Joseph Pally, Katy, TX (US)

Correspondence Address: Benjamin Aaron Adler;ADLER & ASSOCIATES, 8011 Candle Lane, Houston, TX, 77071, US

(21) Appl. No.: 11/445,441

(22) Filed: May 31, 2006

(51) Int. Cl. G06F 9/46

(52) U.S. Cl. 715/700; 719/311

(57) ABSTRACT

Provided herein are a recursive browser system including a recursive web browser, a computer medium storing a plurality of web addresses and/or web location designators and/or action triggers and a matching unit matching the same to one or more corresponding complete Uniform Resource Locator (URL) addresses on the World Wide Web, one or more actual web locations and one or more triggerable actions and a computer system comprising the same. Also provided is a computer-implemented method of retrieving web content using the recursive browser system.

### BACKGROUND OF THE INVENTION

1. Field of the Invention

The present invention relates generally to the fields of computer technology and web browser systems. More specifically, the present invention provides a system and method to navigate within a recursive browser environment using abbreviated web addresses or expressions or locators with simultaneous multiple actions.

2. Description of the Related Art

The Internet is arguably the most important innovation of the computer generation. To browse or surf the World Wide Web (the Web) is the fastest and most popular method of obtaining information today. Nevertheless there is a constant quest to improve the speed and performance of web browsers and to simplify access to information.

Typically, access to web sites requires a knowledge of the URL or web address for the site or at least of the URL for a web site dedicated to search for keywords in web sites that might be the desired web site. Some addresses are long or use alternate or clever spellings, including dashes or underscores, to differentiate it from a similarly named site. To reduce potential misspellings and confusion over names and to aid memory, most browsers provide a favorites, bookmarking or a tabbing function to save the web page associated with the URL once it is displayed. However, to reaccess these sites requires scrolling or scanning a potentially long list of saved pages for the desired link. Also, favorites, for example, are not scaleable.

Current web browsers are primarily read only with little interactive capability. The Internet is “go to and visit” and not part of the experience. A user's experience on the Internet is a temporal series of URLs visited. In addition most users are interested only in snippets of the information available in a web site they visit.

Creating a new browser to address these problems is not an easy solution. It is estimated that a new browser release can cost from $10 million to $100 million. In addition the development and release processes are extremely time consuming. As such, one solution is to use the browser itself to expand browser functionalities.

Thus, there is a significant need in the art for improvements in the area of user-driven experiences. Specifically, the present invention is deficient in systems and methods utilizing a recursive browser to quickly link into specific web sites on the Internet or to achieve actions using the web that are different from visiting a web site associated with a URL. The present invention fulfills this long-standing need and desire in the art.

### SUMMARY OF THE INVENTION

The present invention is directed to a computer system, comprising a recursive web browser, a plurality of stored user-accessible abbreviated web addresses, web location designators or triggers associated with an action on the web or a combination thereof and a unit for matching one or more of said stored abbreviated web addresses to one or more corresponding complete Uniform Resource Locator (URL) addresses or one or more of the stored web location designators to one or more corresponding actual web locations or one or more of said triggers to one or more corresponding actions on the web or a combination thereof. The present invention is directed to a related computer system further comprising means for launching a user-requested action.

The present invention also is directed to a recursive browser system, comprising a recursive browser, a unit for matching one or more abbreviated web addresses to one or more corresponding complete Uniform Resource Locator (URL) addresses or one or more web location designators to one or more corresponding actual web locations or one or more triggers to one or more corresponding actions on the web or a combination thereof, and means for detecting and retrieving one or more web pages associated with the URLs or content associated with the actual web location(s) or for triggering the one or more actions or a combination thereof. The present invention is directed to a related recursive browser system further comprising means for launching a user-requested action. In another related invention the recursive browser system further comprises means for recursively displaying a plurality of retrieved web pages within a recursive browser window.

The present invention is directed further to a recursive web browser, comprising a browser window configured to recursively display one or more web pages therewithin, means for launching a user-requested address or action and a unit for matching one or more abbreviated web addresses to one or more corresponding complete Uniform Resource Locator (URL) addresses or one or more web location designators to one or more corresponding actual web locations or one or more triggers to one or more corresponding actions on the web or a combination thereof.

The present invention is directed further still to a computer-readable medium storing a plurality of abbreviated web addresses each corresponding to one or more complete Uniform Resource Locator (URL) addresses or a plurality of web location designators each corresponding to one more actual web locations or a plurality of triggers corresponding to one or more user-requested actions or a combination thereof. Each of the abbreviated web addresses, web location designators or triggers is adapted to be accessed from the computer medium and to be launched in a recursive browser environment where one or more web pages associated with the one or more complete URLs are retrieved or one or more actual locations are accessed or one or more actions are triggered or a combination thereof.

The present invention is directed further still to a computer-implemented method of retrieving web content. The method comprises selecting one or more of a plurality of abbreviated web addresses each corresponding to one or more complete Uniform Resource Locator (URL) addresses or a plurality of web location designators each corresponding to one more actual web locations or a plurality of triggers corresponding to one or more user-requested actions or a combination thereof from a computer medium storing the same and launching the selected abbreviated web address(es), the web location designator(s) or the action trigger(s) or the combination thereof using the recursive browser system described herein. The abbreviated web address(es) are matched to the one or more corresponding complete URLs, the web location designator(s) are matched to the one or more corresponding actual web locations or the trigger(s) are matched to the one or more corresponding actions and the content associated with the URL(s) or the actual web location(s) is displayed or the triggered action(s) are implemented in a recursive browser window.

Other and further aspects, features and advantages of the present invention will be apparent from the following description of the presently preferred embodiments of the invention. These embodiments are given for the purpose of disclosure.

### BRIEF DESCRIPTION OF THE DRAWINGS

So that the matter in which the above-recited features, advantages and objects of the invention, as well as others which will become clear, are attained and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIG. 1A is a block diagram depicting an overview of accessing a web page using an abbreviated web address in a recursive browser referred to as a zBrowser.

FIG. 1B is a flowchart of the processes to proceed from an abbreviated web address to an action matched therewith to subsequently display the web page associated with the abbreviated web address.

FIG. 2A depicts a zBrowser displaying the Google™web page accessed using the g. web address.

FIG. 2B depicts a zBrowser displaying the results of a search of the term “cars” by the search engine Yahoo™ using the cars y. web address.

FIG. 2C depicts a zBrowser window displaying the buy passenger vehicles web page on the eBay® web site using the cars e.b web address.

FIG. 2D depicts a zBrowser displaying the results of a search of the term “cars” by multiple search engines using the abbreviated web address cars m.

FIG. 3 depicts a zBrowser displaying a cascade of multiple uniform resource locators.

### DETAILED DESCRIPTION OF THE INVENTION

In one embodiment of the present invention there is provided a computer system, comprising a recursive web browser; a plurality of stored user-accessible abbreviated web addresses, web location designators or triggers associated with an action on the web or a combination thereof; and a unit for matching one or more of the stored abbreviated web addresses to one or more corresponding complete Uniform Resource Locator (URL) addresses or one or more of the stored web location designators to one or more corresponding actual web locations or one or more of the triggers to one or more corresponding actions on the web or a combination thereof.

Further to this embodiment the computer system comprises means for launching a user-requested action. One example of such means is an an action bar within a recursive browser window. Another example is an address bar located in a browser platform associated with the recursive web browser which triggers the action bar.

In these embodiments the matching unit comprises an aliasing process for said one or more user-requested abbreviated web addresses. Also, the matching unit further may comprise a searching process for searching an array of actions for one or more actions corresponding to the one or more web address aliases. In addition, the matching unit further may comprise a mapping process for mapping one or more of said corresponding actions to one or more complete uniform resource locator addresses.

Also, in these embodiments the recursive browser is configured to recursively display a plurality of web pages within said recursive browser window. In one aspect the plurality of web pages may be displayed as an array. In another aspect the plurality of web pages may be displayed as a cascade. In yet another aspect the plurality of web pages may be displayed in any user-positioned configuration.

In addition, in these embodiments the abbreviated web address may comprise one or more letters or a symbol designating one or more known web sites or a web page therewithin. Furthermore, the abbreviated web address may comprise a dot designation. Alternatively, the abbreviated web address further may comprise a top level domain name. In one aspect, the top level domain name may be abbreviated. Further still, the abbreviated web address further may comprise a descriptive parameter, a functional parameter or a combination thereof.

In another embodiment of the present invention there is provided a recursive browser system, comprising a recursive browser; a unit for matching one or more abbreviated web addresses to one or more corresponding complete Uniform Resource Locator (URL) addresses or one or more web location designators to one or more corresponding actual web locations or one or more triggers to one or more corresponding actions on the web; and means for detecting and retrieving one or more web pages associated with the URLs or content associated with the actual web location(s) or for triggering the one or more actions or a combination thereof or a combination thereof.

Further to this embodiment the computer system comprises means for launching a user-requested action. One example of such means is an an action bar within a recursive browser window. Another example is an address bar located in a browser platform associated with the recursive web browser which triggers the action bar. Further still to these embodiments the recursive browser system may comprise means for recursively displaying a plurality of retrieved web pages within a recursive browser window. In one example the plurality of web pages may be displayed as an array. In another example the plurality of web pages may be displayed as a cascade. In yet another aspect the plurality of web pages may be displayed in any user-positioned configuration.

In these embodiments the web address matching unit may comprise an aliasing process for the one or more user-requested abbreviated web addresses; a searching process for searching an array of actions for one or more actions corresponding to one or more web address aliases; and a mapping process for mapping one or more of said corresponding actions to one or more complete uniform resource locators. In these embodiments and aspects thereof the abbreviated web address is as described supra.

In yet another embodiment of the present invention there is provided a recursive web browser comprising a browser window configured to recursively display one or more web pages therewithin; means for launching a user-requested address or action; and a unit for matching one or more abbreviated web addresses to one or more corresponding complete Uniform Resource Locator (URL) addresses or one or more web location designators to one or more corresponding actual web locations or one or more triggers to one or more corresponding actions on the web or a combination thereof.

In this embodiment examples of the means for launching a user-requested address or action may be an action bar within the recursive browser window or an address bar in a browser platform associated with the recursive web browser which triggers the action bar. Also in this embodiment the more than one web pages may be displayed as an array or as a cascade. Furthermore, in this embodiment the plurality of web pages may be displayed in any user-positioned configuration. Furthermore, in this embodiment the abbreviated web address is as described supra.

In yet another embodiment of the present invention there is provided a computer-readable medium storing a plurality of abbreviated web addresses each corresponding to one or more complete Uniform Resource Locator (URL) addresses or a plurality of web location designators each corresponding to one more actual web locations or a plurality of triggers corresponding to one or more user-requested actions or a combination thereof, each of the abbreviated web addresses, web location designators or triggers adapted to be accessed from the computer-readable medium and to be launched in a recursive browser environment wherein one or more web pages associated with the one or more complete URLs are retrieved or one or more actual locations are accessed or one or more actions are triggered or a combination thereof. In this embodiment the web addresses and recursive browser are as described supra.

In yet another embodiment of the present invention there is provided a computer-implemented method of retrieving web content, comprising selecting one or more of a plurality of abbreviated web addresses each corresponding to one or more complete Uniform Resource Locator (URL) addresses or a plurality of web location designators each corresponding to one more actual web locations or a plurality of triggers corresponding to one or more user-requested actions or a combination thereof from a computer medium storing the same; launching the selected abbreviated web address(es), the web location designator(s) or the action trigger(s) or the combination thereof using the recursive browser system described supra; matching the abbreviated web address(es) to its one or more corresponding complete URLs, the web location designator(s) to its one or more corresponding actual web locations or the trigger(s) to its one or more corresponding actions; and displaying content associated with said URL(s) or said actual web location or implementing said triggered action(s) in a recursive browser window. The computer medium, the web addresses and the recursive browser system are as described supra.

As used herein, the term “a” or “an” may mean one or more. As used herein in the claim(s), when used in conjunction with the word “comprising”, the words “a” or “an” may mean one or more than one. As used herein “another” or “other” may mean at least a second or more of the same or different claim element of components thereof.

As used herein, the term(s) “recursive browser” or “zBrowser” refers to a browser that uses existing browsers to enhance their functionality and to provide 3 dimensional multipart full browser functionality to improve browser experience.

As used herein, the term “Action Bar” refers to a targeting bar, which may be the conventional URL bar, that can also be triggered from html or a href calls to invoke one or more web sites, web services, or action triggers. An address, as described herein, may be entered into the Action Bar.

As used herein, the term(s) “address” refers to, but is not limited to, one or more web addresses, action triggers, script or script calls, Simple Object Access Protocol (SOAP) calls, or web services, for example, but not limited to, interactive technologies, such as Microsoft® ActiveX®.

The present invention provides a user-specified web browsing system and methods comprising quick browse functions for navigating the Internet. The system comprises a recursive browser or zBrowser configured to fully start from known browser platforms, such as, but not limited to, Internet Explorer or Mozilla Firefox. The browser system is effective to expand browser functionalities and to enhance the user's real time experience.

Generally, the recursive browser comprises an Action Bar within the zBrowser page as an entry point for any action trigger performable within the zBrowser. For example, the Action Bar may include, inter alia, an equivalent of a conventional URL bar adapted for short or abbreviated or customized web addresses, web location designators or action triggers or any combination of the same. Examples of triggerable actions include, but are not limited to, a call for an RSS feed, a call for Javascript™ scripting language, a SOAP call, or other interactive or script triggers.

Also, the Action Bar may be triggered by an entry into a URL bar in a conventional browser platform from which the recursive browser starts. Furthermore, the Action Bar may be triggered from a page link within a web page. The combination of the Action Bar and the zBrowser decreases the time usually required to navigate the Internet and access and display the requested web sites or web pages or other web content or execute the triggered action when using standard web browsers. The logic to launch a user-requested action may be retrieved from data stored in an email, stored on disk, stored in internet files or from any other utilizable computer storage medium.

The recursive browser enables web pages to be displayed with any arbitrary layout or spacing within the browser window. For example, the web pages may be displayed as an array where the web pages are equally viewable and browsable. Also, the web pages may be displayed as a cascade within the browser window. Alternatively, the web pages may be displayed in any user-positioned configuration.

As described herein, the invention provides a number of advantages and uses. Embodiments of the present invention are better described below with reference to the Figures, however, such description or reference is not meant to limit the present invention in any fashion. The embodiments and variations described in detail herein are to be interpreted by the appended claims and equivalents thereof.

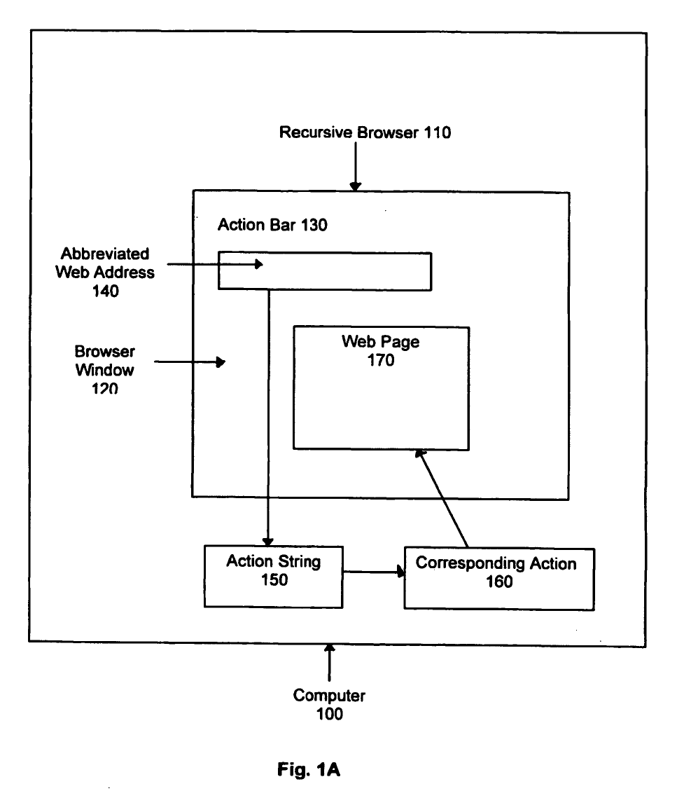

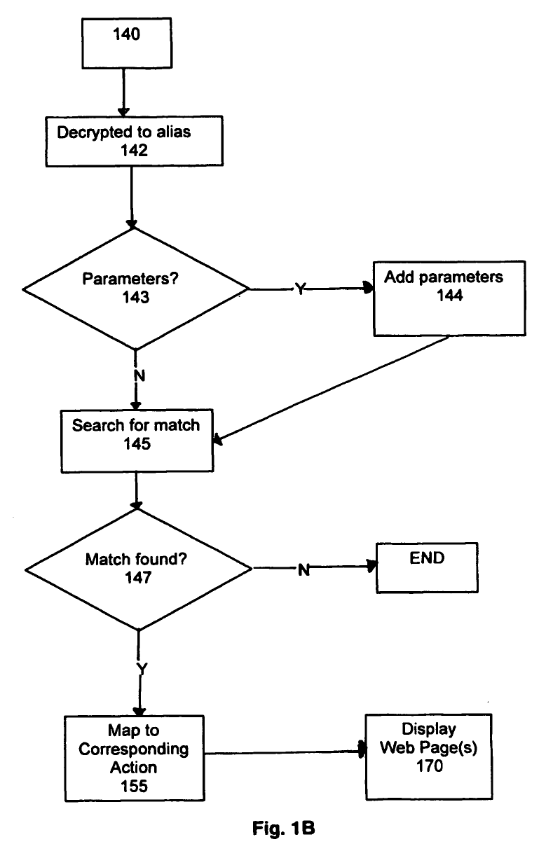

FIG. 1A is a block diagram depicting a computer 100 with a zBrowser 110 with a browser window 120, including an Action Bar 130 therein. In an overview to retrieve and display a web site or web page content, a user may enter an abbreviated web address 140 into the Action Bar 130 and launch the request for the web page 170. The web address 140 is decrypted to an action string 150 and matched to and mapped into a corresponding action 160. The zBrowser displays the appropriate web page 170 corresponding to the action 160.

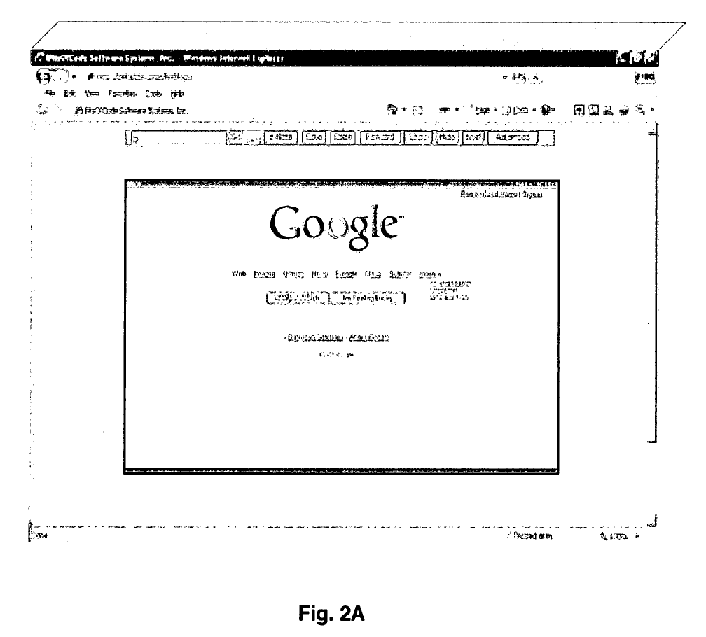

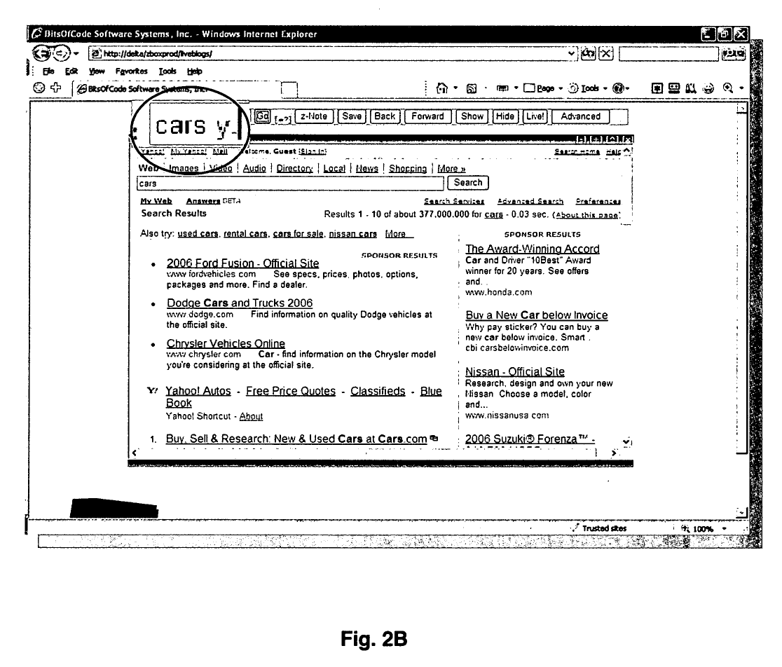

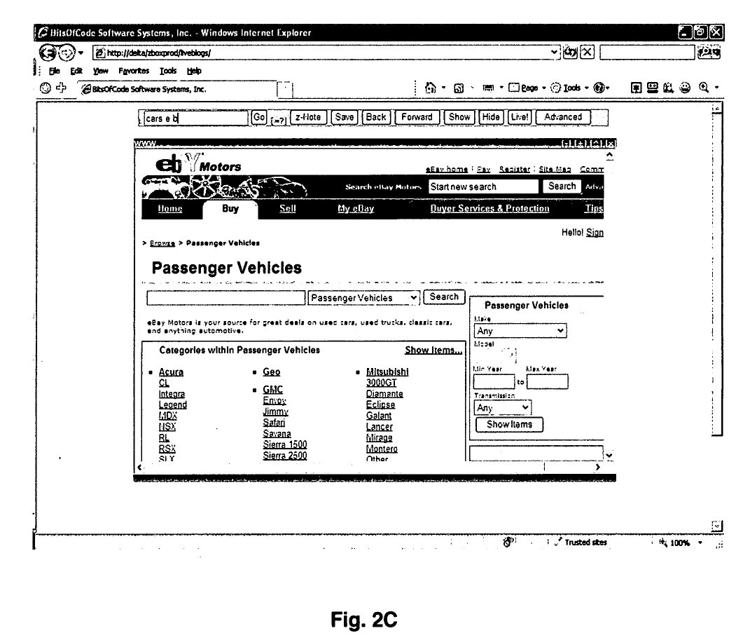

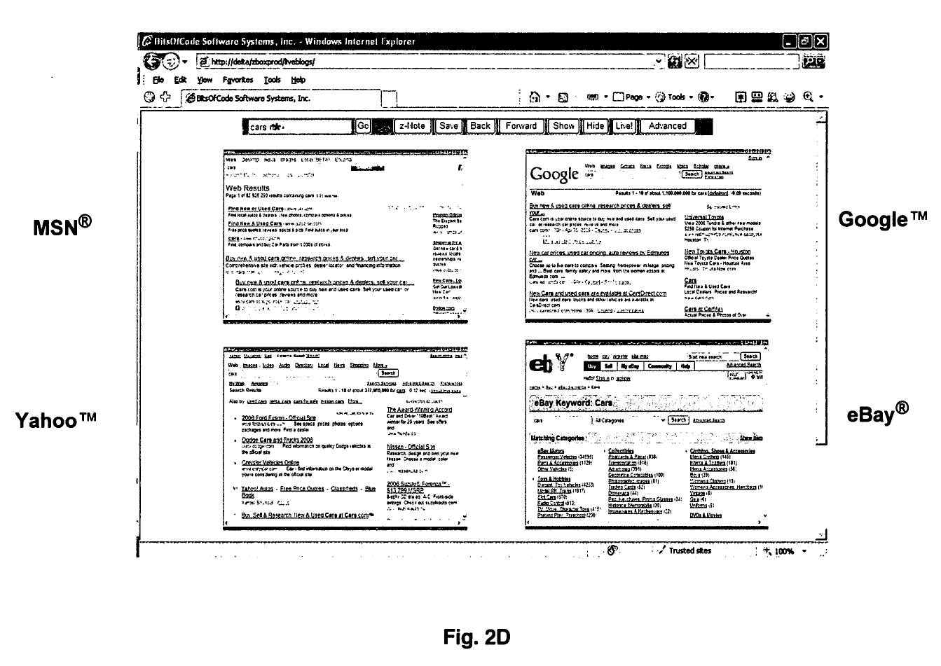

With continued reference to FIG. 1A, FIG. 1B is a flow chart of the abbreviated web address decrypting, matching and mapping processes occuring at 150 and 160 in FIG. 1A. As discussed with reference to FIGS. 2B-2C below, an abbreviated web address may comprise a descriptive and/or functional parameter.

In step 142 the web address 140 is decrypted to its alias. Although not shown in this Figure, this process also may be triggered from a page link using BTo or Browse To=B. (“URL”), for example, BTo (“cars g.”). The string comprising the web address 140 is fragmented to determine if descriptive and/or functional parameter(s) are present within the string at 143. If no parameters are present, the process proceeds to step 145, otherwise the process proceeds to step 144. In step 144, the parameter(s) are added to the alias and the process proceeds to step 145.

In step 145 a lookup array is searched for an action string 150 matching the alias. If a match is found, the process takes the action string 150 and proceeds to step 155, otherwise the process ends and no web page 170 is displayed. In step 155, the action string 150 is mapped to the corresponding action 160 and the web page 170 is displayed.

FIGS. 2A-2D illustrate that the abbreviated web address determines how the zBrowser displays accessed web page(s).

The abbreviated web address may be a string comprising an alphabetic character followed by a dot. Each letter designates a specific web site and/or a specific function performable on the web page. The user may retrieve a lookup list of assigned abbreviations from a computer storage medium or other computer-readable medium, as are known and standard in the art, and tailor the list for desired experiences. The list may be stored on the user's computer or may be retrieved using, for example, Internet Explorer, to interact with Applicants' web site www.bitsofcode.com. The lookup list of assigned abbreviations is accessible by typing an initial abbreviation to display the same.

In using the abbreviated web address in the Action Bar, for example, and without being limiting, the string y. may correspond to a searching action using the Yahoo™ search engine or the string g. may correspond to a searching action using the Google™ search engine or the string e. may correspond to a searching action on the eBay® web site. If desired, although not necessary, the string may comprise the top level domain name or the domain suffix, e.g., com, net, etc., as appropriate for the web site. Alternatively, the top level domain name may be in an abbreviated form, such as y.c or g.c. Thus, upon entering these addresses into the Action Bar the Yahoo™ or Google™ or eBay® search pages are accessed by and are displayed within the zBrowser page. A user may then enter keyword(s) in the search bar of the web page. Reference is made to FIG. 2A which illustrates a zBrowser displaying the Google™web page accessed using the g. web address.

Alternatively, a parameter, such as a descriptive searchable keyword, may be included in the string of the abbreviated web address. For example and without being limiting, entering the web address cars y. into the Action Bar on the zBrowser results in a web page containing all the sites found by the Yahoo™ search engine containing the keyword cars. Furthermore, a specific order of the string components is not required, i.e., the abbreviated web address also may be entered as y. cars. Reference is made to FIG. 2B which illustrates a zBrowser displaying the Yahoo™web page accessed using the cars y. web address.

Furthermore, the string may include a second parameter comprising an alphabetic letter or word to designate a specific function within a web site enabling more than one function. For example, and without being limiting, the string e.b or e. buy may correspond to the action of buying on eBay® or e.s or e. sell may correspond to the action of selling on eBay®. The zBrowser displays the web pages within the eBay® web site for buying or selling items. As discussed supra, the first or descriptive parameter also may be included in these web addresses. Using one of the web address cars e.b or car e. buy accesses the web page within eBay® web site for buying cars. Reference is made to FIG. 2C which illustrates a zBrowser displaying the eBay® web page accessed using the cars e. b web address.

Furthermore, a single abbreviated web address may correspond to several web sites. For example, and without being limiting, a web address utilizing the symbol *. may correspond to individual search actions using the search engines provided by Google™, Yahoo™, MSN®, and eBay® web sites. As discussed herein descriptive or functional parameters may be included in the abbreviated web address. Reference is made to FIG. 2D which illustrates a zBrowser simultaneously displaying the web pages accessed using the cars *. web address as an array within the zBrowser. Alternatively, more than one abbreviated web address may entered into the Action Bar.

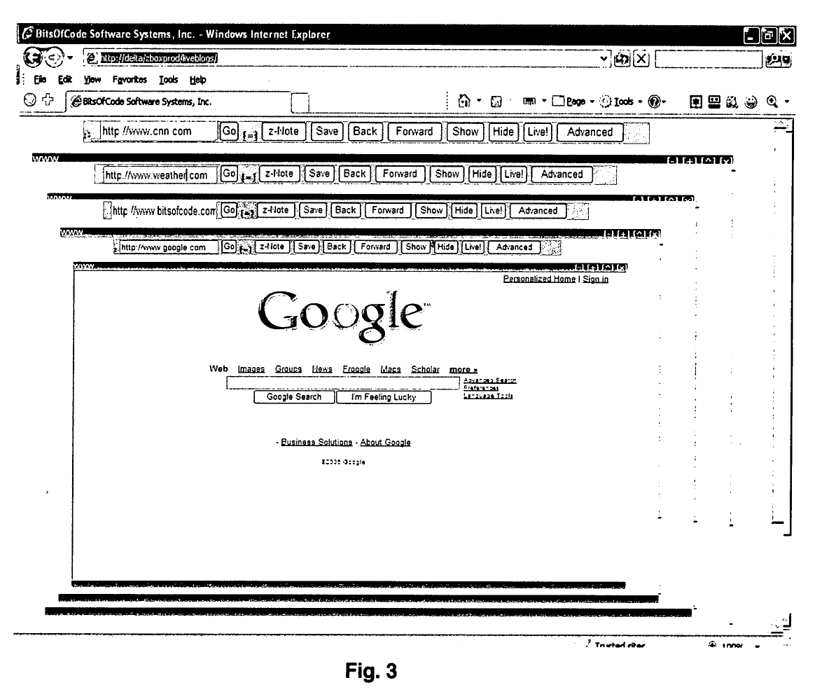

FIG. 3 illustrates that the zBrowser can recursively mirror multiple URLs in a cascading format. The recursive browser retains the full functionality of a recursive browser inside itself.

One skilled in the art will appreciate readily that the present invention is well adapted to carry out the objects and obtain the ends and advantages inherent herein. The present examples, along with the methods, procedures, systems, and/or applications described herein are presently representative of preferred embodiments, are exemplary and are not intended as limitations on the scope of the invention. Changes therein and other uses will occur to those skilled in the art which are encompassed within the spirit of the invention as defined by the scope of the claims.

What is claimed is:

1. A computer system, comprising:
a recursive web browser;
a plurality of stored user-accessible abbreviated web addresses, web location designators or triggers associated with an action on the web or a combination thereof; and
a unit for matching one or more of said stored abbreviated web addresses to one or more corresponding complete Uniform Resource Locator (URL) addresses or one or more of said stored web location designators to one or more corresponding actual web locations or one or more of said triggers to one or more corresponding actions on the web or a combination thereof.

2. The computer system of claim 1, further comprising means for launching a user-requested action.

3. The computer system of claim 2, wherein said means for launching a user-requested action is an action bar within a recursive browser window or an address bar located in a browser platform associated with the recursive web browser which triggers the action bar.

4. The computer system of claim 1, wherein said matching unit comprises an aliasing process for said one or more user-requested abbreviated web addresses.

5. The computer system of claim 4, wherein said matching unit further comprises a searching process for searching an array of actions for one or more actions corresponding to one or more web address aliases.

6. The computer system of claim 5, wherein said matching unit further comprises a mapping process for mapping one or more of said corresponding actions to one or more complete URL addresses.

7. The computer system of claim 1, wherein said recursive browser is configured to recursively display a plurality of web pages within a recursive browser window.

8. The computer system of claim 7, wherein said plurality of web pages is displayed as an array or as a cascade or in any user-positioned configuration.

9. The computer system of claim 1, wherein said abbreviated web address comprises:
one or more letters or a symbol designating one or more known web sites or a web page therewithin.

10. The computer system of claim 9, wherein said abbreviated web address further comprises a dot designation.

11. The computer system of claim 9, wherein said abbreviated web address further comprises a top level domain name.

12. The computer system of claim 11, wherein said top level domain name is abbreviated.

13. The computer system of claim 9, wherein said abbreviated web address further comprises a descriptive parameter, a functional parameter or a combination thereof.

14. A recursive browser system, comprising:
a recursive browser;
a unit for matching one or more abbreviated web addresses to one or more corresponding complete Uniform Resource Locator (URL) addresses or one or more web location designators to one or more corresponding actual web locations or one or more triggers to one or more corresponding actions on the web or a combination thereof; and
means for detecting and retrieving one or more web pages associated with the URLs or content associated with the actual web location(s) or for triggering the one or more actions or a combination thereof.

15. The recursive browser system of claim 14, further comprising means for launching a user-requested action.

16. The recursive browser system of claim 15, wherein said means for launching a user-requested address action is an action bar within a recursive browser window or an address bar located in a browser platform associated with the recursive web browser which triggers the action bar.

17. The recursive browser system of claim 14, further comprising means for recursively displaying a plurality of retrieved web pages within a recursive browser window.

18. The recursive browser system of claim 17, wherein said plurality of web pages are displayed as an array or as a cascade or in any user-positioned configuration.

19. The recursive browser system of claim 14, wherein said matching unit comprises:
an aliasing process for said one or more user-requested abbreviated web addresses;
a searching process for searching an array of actions for one or more actions corresponding to one or more web address aliases; and
a mapping process for mapping one or more of said corresponding actions to one or more complete URLs.

20. The recursive browser system of claim 14, wherein said abbreviated web address comprises:
one or more letters or a symbol designating one or more known web sites or a web page therewithin.

21. The recursive browser system of claim 20, wherein said abbreviated web address further comprises a dot designation.

22. The recursive browser system of claim 21, wherein said abbreviated web address further comprises a top level domain name.

23. The recursive browser system of claim 22, wherein said top level domain name is abbreviated.

24. The recursive browser system of claim 20, wherein said abbreviated web address further comprises a descriptive parameter, a functional parameter or a combination thereof.

25. A recursive web browser, comprising:
a browser window configured to recursively display one or more web pages therewithin;
means for launching a user-requested address or action; and
a unit for matching one or more abbreviated web addresses to one or more corresponding complete Uniform Resource Locator (URL) addresses or one or more web location designators to one or more corresponding actual web locations or one or more triggers to one or more corresponding actions on the web or a combination thereof.

26. The recursive web browser of claim 25, wherein more than one of said web pages are displayed as an array or as a cascade or in any user-positioned configuration.

27. The recursive web browser of claim 25, wherein said means for launching a user-requested address or action is an action bar within the recursive browser window or an address bar located in a browser platform associated with the recursive web browser which triggers the action bar.

28. The recursive web browser of claim 25, wherein said matching unit comprises:
an aliasing process for one or more user-requested abbreviated web addresses;
a searching process for searching an array of actions for one or more actions corresponding to one or more web address aliases; and
a mapping process for mapping one or more actions to one or more complete URLs.

29. The recursive web browser of claim 25, wherein said abbreviated web address comprises:
one or more letters or a symbol designating one or more known web sites or a web page therewithin.

30. The recursive web browser of claim 29, wherein said abbreviated web address further comprises a dot designation.

31. The recursive web browser of claim 29, wherein said abbreviated web address further comprises a top level domain name.

32. The recursive web browser of claim 31, wherein said top level domain name is abbreviated.

33. The recursive web browser of claim 29, wherein said abbreviated web address further comprises a descriptive parameter, a functional parameter or a combination thereof.

34. A computer-readable medium storing a plurality of abbreviated web addresses each corresponding to one or more complete Uniform Resource Locator (URL) addresses or a plurality of web location designators each corresponding to one more actual web locations or a plurality of triggers corresponding to one or more user-requested actions or a combination thereof, each of said abbreviated web addresses, web location designators or triggers adapted to be accessed from the computer medium and to be launched in a recursive browser environment wherein one or more web pages associated with said one or more complete URLs are retrieved or one or more actual locations are accessed or one or more actions are triggered or a combination thereof.

35. The computer-readable medium of claim 34, wherein said abbreviated web address comprises:
one or more letters or a symbol designating one or more known web sites or a web page therewithin.

36. The computer-readable medium of claim 35, wherein said abbreviated web address further comprises a dot designation.

37. The computer-readable medium of claim 35, wherein said abbreviated web address further comprises a top level domain name.

38. The computer-readable medium of claim 37, wherein said top level domain name is abbreviated.

39. The computer-readable medium of claim 34, wherein said abbreviated web address further comprises a descriptive parameter, a functional parameter or a combination thereof.

40. A computer-implemented method of retrieving web content, comprising:
selecting one or more of a plurality of abbreviated web addresses each corresponding to one or more complete Uniform Resource Locator (URL) addresses or a plurality of web location designators each corresponding to one more actual web locations or a plurality of triggers corresponding to one or more user-requested actions or a combination thereof from a computer medium storing the same;
launching the selected abbreviated web address(es), the web location designator(s) or the action trigger(s) or the combination thereof using the recursive browser system of claim 13;
matching said abbreviated web address(es) to the one or more corresponding complete URLs, said web location designator(s) to the one or more corresponding actual web locations or the trigger(s) to the one or more corresponding actions; and
displaying content associated with said URL(s) or said actual web location(s) or implementing said triggered action(s) in a recursive browser window.
